(19) United States
(12) Patent Application Publication
(10) Pub. No.: US 2014/0292697 A1
(43) Pub. Date: Oct. 2, 2014

(54) PORTABLE TERMINAL HAVING DOUBLE-SIDED TOUCH SCREENS, AND CONTROL METHOD AND STORAGE MEDIUM THEREFOR

(71) Applicant: CANON KABUSHIKI KAISHA, Tokyo (JP)

(72) Inventor: Yusuke Morishita, Inagi-shi (JP)

(73) Assignee: CANON KABUSHIKI KAISHA, Tokyo (JP)

(21) Appl. No.: 14/231,814

(22) Filed: Apr. 1, 2014

(30) Foreign Application Priority Data
Apr. 1, 2013 (JP) 2013-076197
Mar. 14, 2014 (JP) 2014-051588

(51) Int. Cl. G06F 3/041

(52) U.S. Cl. CPC G06F 3/0416
USPC 345/173

(57) ABSTRACT

A portable terminal having double-sided touch screens and capable of suppressing an erroneous operation to the portable terminal. The portable terminal has a first touch screen combined with a display and has a second touch screen. Which of horizontal and vertical attitudes the portable terminal is in is detected by a detection unit of the portable terminal, and according to a result of the detection, control is performed by a control unit to invalidate an operation to a partial region of the second touch screen.

### BACKGROUND OF THE INVENTION

1. Field of the Invention

The present invention relates to a portable terminal having double-sided touch screens, and a control method for the portable terminal, and a storage medium storing a program for executing the control method.

2. Description of the Related Art

In recent years, portable terminals such as smartphones and tablets have become widespread that have a touch screen (also called a touch panel), and various applications (such as applications for telephone, mail, game, web page browser, schedule management) have also been provided for portable terminals.

The way in which a portable terminal is operated and held by a user varies according to an application used by the user. For example, when playing a game application, the user generally holds the portable terminal horizontally in both hands and operates the portable terminal with both thumbs, as with the case of a home game controller. To write a mail or to browse a web page, the user generally holds the portable terminal vertically in one hand in a manner covering a rear surface of the portable terminal with the holding hand, and operates the portable terminal with the thumb of the holding hand or with a finger of another hand.

A touch screen has touch detection regions respectively corresponding to display objects (e.g., images of operation buttons or keys) that are displayed on the touch screen. When any of the display objects (touch detection regions) is touched, a touch operation is detected. In other words, even if the user erroneously touches any of the touch detection areas, erroneous touching is detected as a touch operation. This poses a problem that an erroneous operation is likely to occur in the touch screen.

When a touch function of the touch screen is enabled in order to accept a user's touch operation, operating power is consumed not only in touch screen regions that function as the touch detection regions, but also in other touch screen regions. This poses a problem of large power consumption of the touch screen.

As described above, the display objects e.g. operation key images are displayed on the touch screen so as to correspond to the touch detection regions. When the user views the touch screen from an oblique direction, operation key images are sometimes seen out of alignment. In that case, the user may touch an operation key image displayed adjacent to a to-be-touched operation key image, resulting in an erroneous operation. To obviate this, a portable terminal device has been proposed (see, for example, Japanese Laid-open Patent Publication No. 2012-037963), in which an inclination of a display surface of the portable terminal device relative to a reference axis is detected and positions of touch detection regions of the touch panel (touch screen) are moved from their reference positions based on the detected inclination, thereby preventing an erroneous operation.

If there is a variation in frequency of use between operation button images displayed on the touch panel (touch screen), a problem is posed that touch panel portions where frequently used operation button images are displayed are deteriorated earlier to shorten the service life of the touch panel. To obviate this, an electronic device has been proposed (see, for example, Japanese Laid-open Patent Publication No. 2002-297316), in which frequencies of use of operation buttons are detected, display positions of images of frequently used operation buttons are changed, and only touch panel regions corresponding to the image display positions are put into a touch-operation enabled state, to thereby suppress deterioration of the touch panel and achieve reduction of power consumption.

Recently, there have appeared game machines having touch screens at their front and rear surfaces (hereinafter, referred to as the double-sided touch screens). It is expected that portable terminals having double-sided touch screens will be widespread in future. A portable terminal having double-sided touch screens can be operated basically in the same manner as a portable terminal having only a front touch screen. For example, the portable terminal can be held in both hands and the rear touch screen can be operated with the first or second fingers of both hands. The portable terminal can also be held in one hand and the rear touch screen can be operated with the first finger of the holding hand.

However, the portable terminal having double-sided touch screens has the following peculiar problems. When the portable terminal is held in one hand, the holding hand may touch the rear touch screen, resulting in an erroneous operation, and a touch operation cannot be made to a region of the rear touch screen covered by the holding hand. If the touch function of the touch screen region covered by the holding hand is enabled, wasteful power consumption is caused.

The above-described problems peculiar to the portable terminal having double-sided touch screens cannot be solved by the method to move the positions of touch detection regions of the touch screen according to the inclination of the display screen as proposed in Japanese Laid-open Patent Publication No. 2012-037963 or by the method to always disable the touch function of touch screen regions other than regions corresponding to image display positions as proposed in Japanese Laid-open Patent Publication No. 2002-297316.

### SUMMARY OF THE INVENTION

The present invention provides a portable terminal having double-sided touch screens and capable of suppressing an erroneous operation to the portable terminal, and provides a control method for the portable terminal and a storage medium storing a program for executing the control method.

According to one aspect of this invention, there is provided a portable terminal having a first touch screen combined with a display and having a second touch screen, which comprises a detection unit configured to detect whether the portable terminal is held horizontally such that long sides of the portable terminal extend in a horizontal direction relative to a horizontal plane or held vertically such that the long sides of the portable terminal extend in a vertical direction relative to the horizontal plane, and a control unit configured according to a result of detection by the detection unit to perform control to invalidate an operation to a partial region of the second touch screen and validate an operation to other regions.

With this invention, it is possible to suppress an erroneous operation to the portable terminal having double-sided touch screens.

Further features of the present invention will become apparent from the following description of exemplary embodiments with reference to the attached drawings.

### BRIEF DESCRIPTION OF THE DRAWINGS

FIG. 1A is a front perspective view showing an external appearance of a portable terminal according to one embodiment of this invention;

FIG. 1B is a rear perspective view of the portable terminal;

FIG. 2 is a block diagram schematically showing the construction of the portable terminal;

FIG. 3A is a view showing an example operation to the portable terminal held in both hands;

FIG. 3B is a view showing an example operation to the portable terminal held in one hand;

FIG. 3C is a view showing an example erroneous operation to the portable terminal held in one hand;

FIG. 4A is a view showing an example effective region of a second touch screen of the portable terminal held in both hands;

FIG. 4B is a view showing an example effective region of the second touch screen of the portable terminal held in one hand;

FIG. 5 is a flowchart showing procedures of a touch screen control process executed by the portable terminal;

FIG. 6A is a view showing an example where an icon that indicates the ineffective and effective regions of the second touch screen of the vertically oriented portable terminal that have been set in the touch screen control process of FIG. 5 is displayed on a liquid crystal display of the portable terminal;

FIG. 6B is a view showing an example where an icon that indicates the effective region of the second touch screen of the horizontally oriented portable terminal is displayed on the liquid crystal display;

FIG. 7 is a view showing an example change of the icon with a change of the effective region or the ineffective region set on the second touch screen in the touch screen control process of FIG. 5; and

FIG. 8 is a flowchart showing procedures of a touch screen control process in which an icon indicating the ineffective and effective regions set on the second touch screen is screen-displayed.

### DESCRIPTION OF THE EMBODIMENTS

The present invention will now be described in detail below with reference to the drawings showing a preferred embodiment thereof.

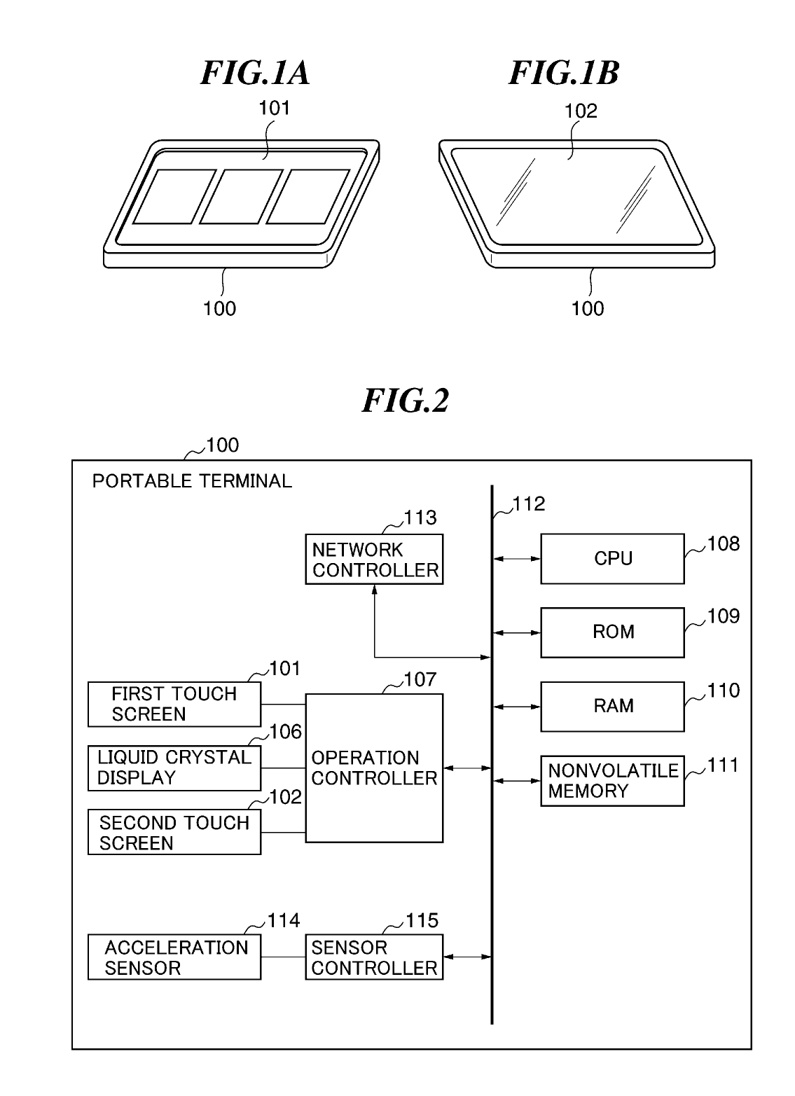

FIGS. 1A and 1B show an external appearance of a portable terminal 100 according to one embodiment of this invention.

As shown in FIGS. 1A and 1B, the portable terminal 100 is provided at its front side with a first touch screen 101 constituted by a transparent material and with a liquid crystal display (denoted by reference numeral 106 in FIG. 2) disposed beneath and combined with the first touch screen 101. The portable terminal 100 is also provided at its rear side with a second touch screen 102.

A user can operate the first and second touch screens 101, 102 independently of each other, thereby capable of, for example, selecting an operation mode, setting various functions, giving an instruction for operation, and selecting and moving image data at the time of editing the image data.

Furthermore, the user can make operations such as touching, dragging, pinching, and flicking on the first touch screen 101 while causing image data to be displayed on the liquid crystal display 106 (display), thereby capable of, for example, designating a desired coordinate position on the displayed image.

FIG. 2 schematically shows the construction of the portable terminal 100.

As shown in FIG. 2, the portable terminal 100 has a CPU 108, a ROM 109, a RAM 110, a nonvolatile memory 111, a network controller 113, an operation controller 107, and a sensor controller 115, which are connected to a system bus 112.

The operation controller 107 is connected with the first touch screen 101, the second touch screen 102, and the liquid crystal display 106, and the sensor controller 115 is connected with an acceleration sensor 114.

The CPU 108 controls the entire portable terminal 100, and provides various functions by executing programs such as an OS (operating system) and application software read from the nonvolatile memory 111.

The RAM 110 is a system work memory for use when the CPU 108 executes programs. The ROM 109 is stored with a BIOS (basic input output system), a program for starting the OS, a setting file, and the like. The nonvolatile memory 111 is stored with system software, etc.

The network controller 113 wirelessly communicates with an external device by means of a WLAN communication system, a 3G system, or the like. On the liquid crystal display 106, information is drawn with predetermined resolution and colors based on screen information instructed by a program. For example, a GUI (graphical user interface) screen is displayed on the liquid crystal display 106, and various windows and data required for operation are displayed on the GUI screen.

The operation controller 107 transmits and receives data, information, and control signals to and from the first touch screen 101, the second touch screen 102, and the liquid crystal display 106. For example, coordinate information obtained by each of the first and second touch screens 101, 102 is transmitted to the operation controller 107. The liquid crystal display 106 receives image data to be displayed from the operation controller 107.

Furthermore, the operation controller 107 temporarily stores, into the RAM 110, data and information used to control the first touch screen 101, the second touch screen 102, or the liquid crystal display 106.

The acceleration sensor 114 detects gravity acceleration components in three axis directions, and transmits signals indicating the detected gravity acceleration components to the sensor controller 115. The sensor controller 115 detects an attitude (orientation) of the portable terminal 100 from the acceleration component signals transmitted from the acceleration sensor 114.

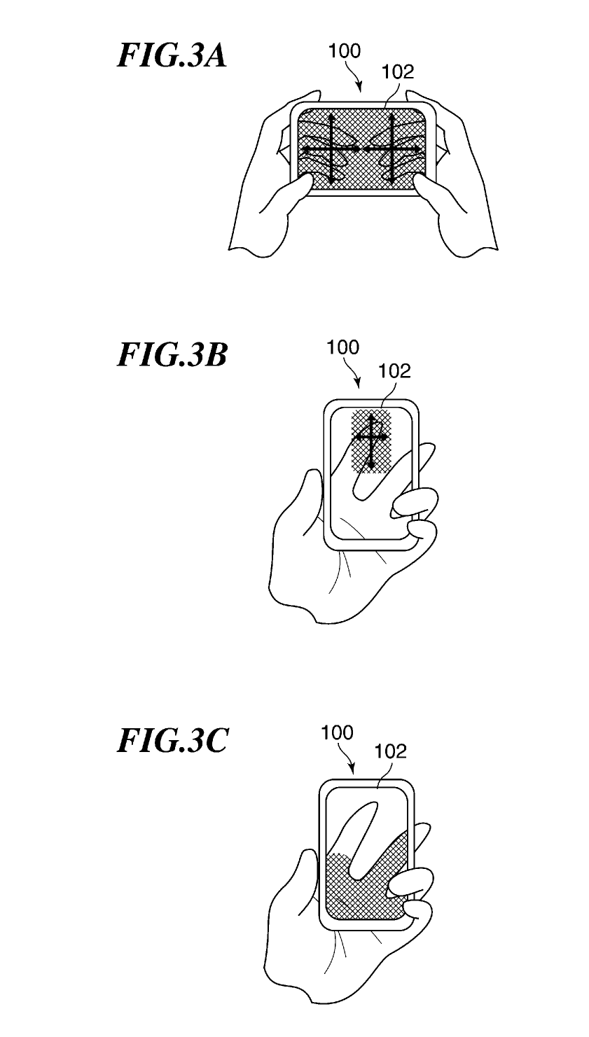

FIG. 3A shows an example operation to the portable terminal 100 held in both hands. As shown in FIG. 3A, the user can bring the portable terminal 100 (which is formed into a rectangular shape as seen in plan) into a horizontal attitude where long sides of the portable terminal 100 extend in a left-right direction as seen from the user or in a horizontal direction relative to a horizontal plane, and can hold both ends of the portable terminal 100 by both hands. In that case, the user can operate the first touch screen 101 with both thumbs and can operate the second touch screen 102 with the first or second fingers of the both hands. More specifically, as shown by cross hatching and two cross arrows in FIG. 3A, the user can perform operations to the entire region of the second touch screen 102 by using fingers of the both hands.

FIG. 3B shows an example operation to the portable terminal 100 held in one hand. As shown in FIG. 3B, the user can bring the portable terminal 100 into a vertical attitude where the long sides of the portable terminal 100 extend in a vertical direction as seen from the user or in a vertical direction relative to the horizontal plane, and can hold the portable terminal 100 by one hand, In that case, the user can operate the first touch screen 101 with the thumb of the holding hand or with one or more fingers of another hand.

When the portable terminal 100 is held in one hand, a region of the second touch screen 102 to which an operation can be performed becomes more restricted than when the portable terminal 100 is held in both hands. For example, when the second touch screen 102 is operated by the first finger of the holding hand, a region of the second touch screen 102 to which an operation can be performed with the first finger is restricted as shown by a crossed arrow in FIG. 3B, and inoperable regions are produced on the second touch screen 102.

FIG. 3C shows an example erroneous operation to the portable terminal held in one hand. In the example of FIG. 3C, the user holds the portable terminal 100 in a manner covering the rear surface of the portable terminal 100 with the holding hand. In that case, the palm of the holding hand may touch the second touch screen 102 to cause an erroneous operation.

To obviate this, e.g. a partial area of the second touch screen 102 is invalidated in this embodiment. If the partial area of the touch screen is invalidated, even when operation to the partial area is performed by the user, the portable terminal 100 does not execute processing corresponding to the operation.

The partial area can be invalidated by cutting off the supply of power required for detection of operation to the partial area to be invalidated. In that case, power consumption can be reduced. It should be noted that instead of cutting off the power supply for operation detection, the supplied power may be reduced in order to lower the sensitivity of detection of a touch operation. Alternatively, the partial region can be invalidated by software control to ignore a detection signal output from the touch screen in response to an operation to the partial region to be invalidated. Hereinafter, the invalidated region will be referred to as the ineffective region, and the non-invalidated region will be referred to as the effective region.

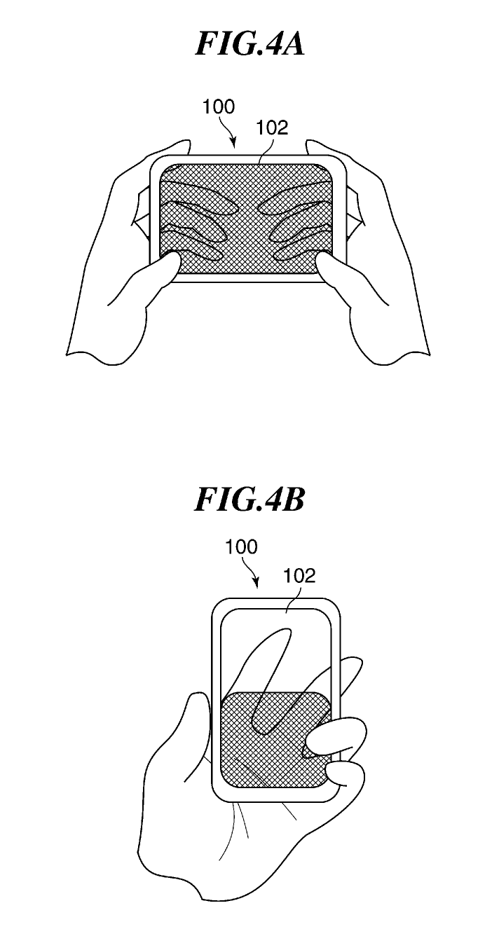

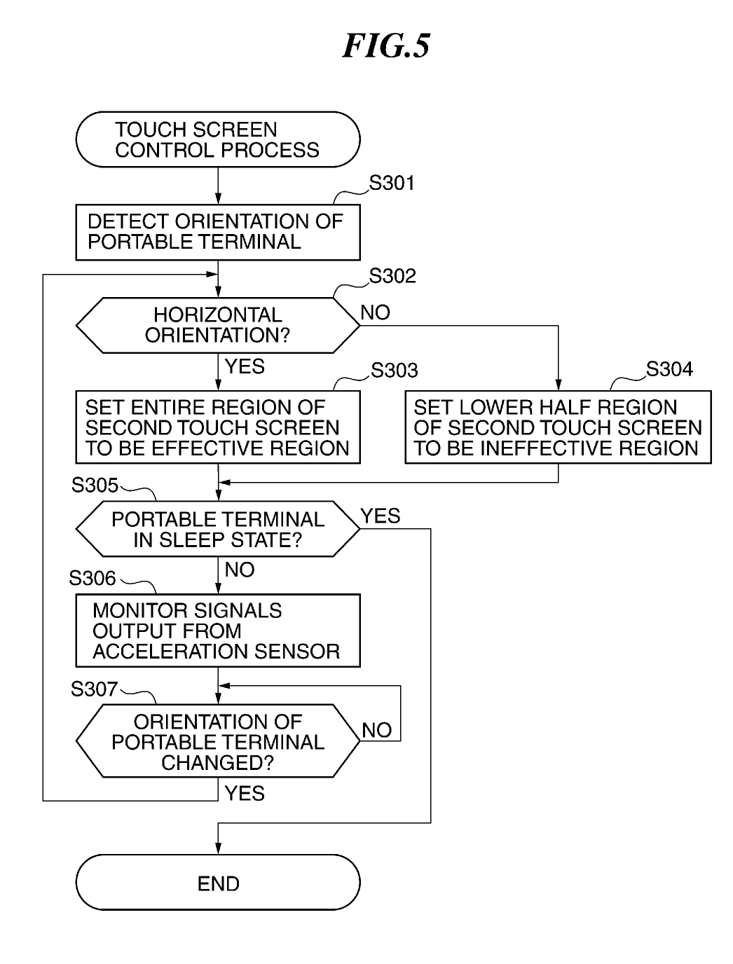

FIG. 4A shows an example effective region of the second touch screen 102 of the portable terminal 100 held in both hands, and FIG. 4B is an example effective region of the second touch screen 102 of the portable terminal 100 held in one hand.

As already described, when the portable terminal 100 is held in both hands, the user can make an operation to the entire region of the second touch screen 102 with both hands. In other words, the entire region of the second touch screen 102 becomes the effective region.

On the other hand, when the portable terminal 100 is held in one hand, there is a fear that the palm of the holding hand touches the second touch screen 102, resulting in an erroneous operation. To obviate this, touch screen regions to which the palm of the holding hand may touch are set to be ineffective regions, whereas the other touch screen regions are set to be effective regions. It should be noted that if it is assumed that an operation only with the first finger (such as a screen scrolling operation) is performed, only a touch screen region corresponding to a movable range of the first finger may be set as the effective region.

FIG. 5 shows in flowchart the procedures of a touch screen control process executed by the portable terminal 100.

Referring to FIG. 5, the sensor controller 115 of the portable terminal 100 detects an orientation of the portable terminal 100 from signals output from the acceleration sensor 114 (step S301), and determines whether the orientation of the portable terminal 100 is horizontal (step S302). Steps S301 and S302 correspond to a detection unit of this invention that determines which of horizontal and vertical attitudes the attitude of the portable terminal 100 is.

If the orientation of the portable terminal 100 is horizontal (YES to step S302), i.e., if the portable terminal 100 is held by the user in both hands, the operation controller 107 controls the second touch screen 102 in such a manner that the entire region of the second touch screen 102 is set to be the effective region as shown in FIG. 4A (step S303), whereby an operation to the second touch screen 102 is validated in the entire region of the second touch screen 102.

On the other hand, if the orientation of the portable terminal 100 is not horizontal (NO to step S302), i.e., if the portable terminal 100 is vertical in orientation and held by the user in one hand, the operation controller 107 controls the second touch screen 102 in such a manner that a lower half region of the second touch screen 102 to which the palm of the holding hand may touch is set to be the ineffective region as shown in FIG. 4B (step S304), whereby an operation to the second touch screen 102 is invalidated in the region to which the user's hand may touch.

In step S305, the CPU 108 determines whether the portable terminal 100 is in a sleep state. If the portable terminal 100 is in a sleep state (YES to step S305), the present process is completed. On the other hand, if the portable terminal 100 is not in a sleep state (NO to step S305), the sensor controller 115 monitors the signals output from the acceleration sensor 114 (step S306), thereby continuing to detect the orientation of the portable terminal 100.

In step S307, the sensor controller 115 determines whether the orientation of the portable terminal 100 has changed. If the orientation of the portable terminal 100 has not changed (NO to step S307), the process returns to step S307. On the other hand, if the orientation of the portable terminal 100 has changed (YES to step S307), the process returns to step S302.

According to the touch screen control process of FIG. 5, when the portable terminal 100 is horizontal in orientation, the entire surface of the second touch screen 102 is set to be the effective region, whereby an operation to the second touch screen 102 can be performed on the entire surface of the second touch screen 102. On the other hand, if the portable terminal 100 is vertical in orientation, the lower half region of the second touch screen 102 to which the user's hand may touch is set to be the ineffective region. This makes it possible to suppress an erroneous operation to the portable terminal having rear touch screen, which would be caused mainly due to the way of holding the portable terminal by the user. In addition, power consumption can be reduced by cutting off the power supply for operation detection to the touch screen region that is to be invalidated.

At least one of indications respectively indicating the effective and ineffective regions of the second touch screen 102 having been set in the touch screen control process can be displayed on the liquid crystal display 106.

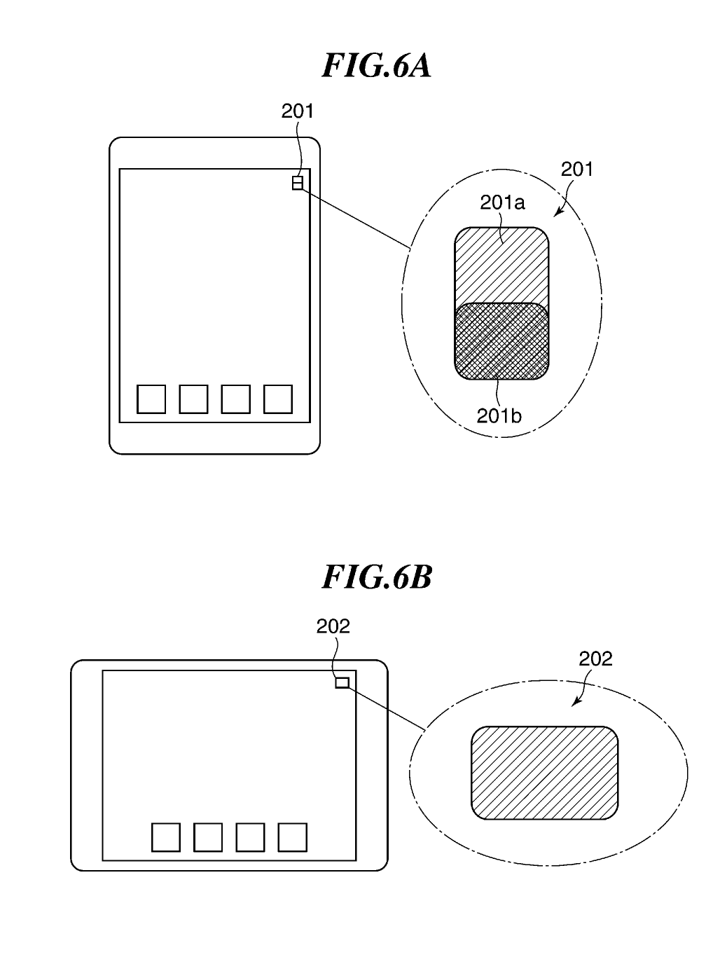

FIG. 6A shows an example where an indication (icon 201) that indicates the ineffective and effective regions of the vertically oriented second touch screen 102 that have been set in the touch screen control process of FIG. 5 is displayed at upper right of the screen of the liquid crystal display 106. The icon 201 of FIG. 6A has an upper half 201a that indicates the effective region of the second touch screen 102 and a lower half 201b that indicates the ineffective region of the second touch screen 102.

It should be noted that as shown by hatching and cross hatching within an ellipse indicated by a one-dotted chain line in right half of FIG. 6A, the upper half 201a of the icon indicating the effective region and the lower half 201b of the icon indicating the ineffective region are displayed in patterns different from each other, but this is not limitative. For example, the upper and lower halves of the icon can be displayed in colors different from each other. Alternatively, words such as “effective” and “ineffective” can be displayed in the upper and lower halves of the icon. This allows the upper and lower halves of the icon to be discriminated visually, and accordingly the user can easily recognize the effective and ineffective regions of the second touch screen 102.

FIG. 6B shows an example where an indication (icon 202) that indicates the effective region set on the horizontally oriented second touch screen 102 is displayed at upper right of the screen of the liquid crystal display 106. The icon 202 shown in FIG. 6B indicates that the entire surface of the second touch screen 102 is the effective region.

It should be noted that as shown by hatching in an ellipse indicated by a one-dotted chain line in right part of FIG. 6B, the entire icon 202 is indicated in the same pattern, but this is not limitative. For example, the entire icon can be displayed in the same color, or a word such as “effective” can be displayed in the icon. This enables the user to easily recognize that the entire region of the second touch screen 102 is the effective region.

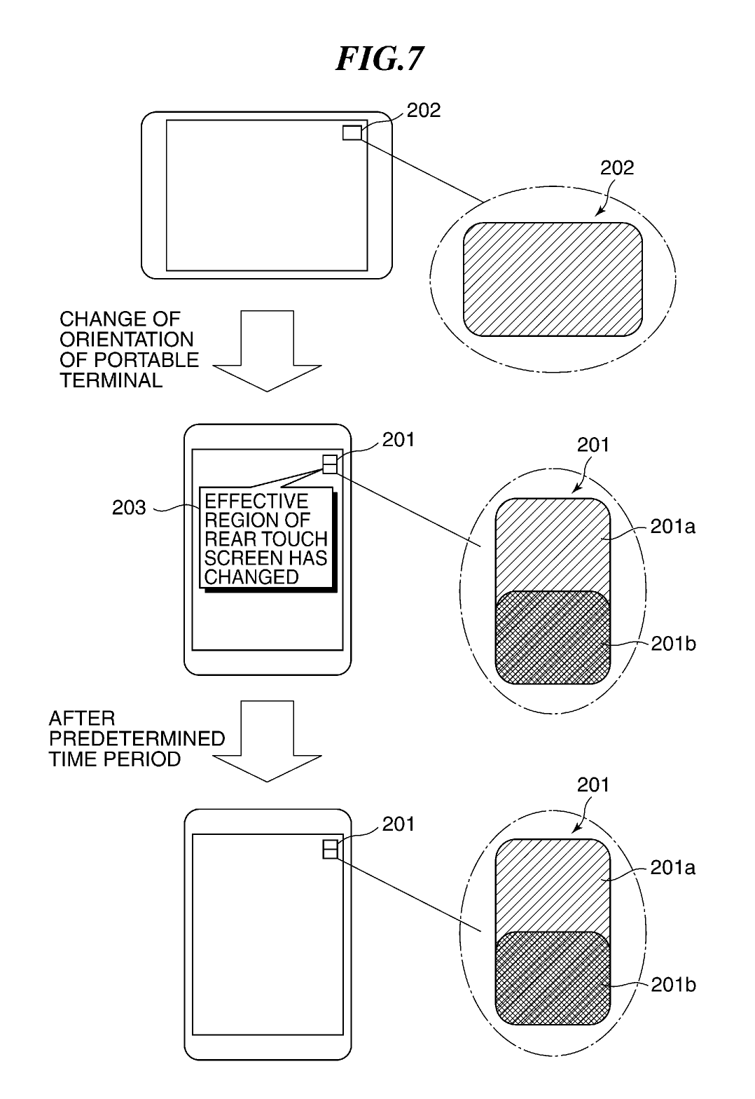

FIG. 7 shows an example change of the icon with a change of the effective region or the ineffective region set on the second touch screen 102 in the touch screen control process of FIG. 5.

In FIG. 7, there is shown an example where the icon changes with a change in attitude of the portable terminal 100 from horizontal to vertical. When the portable terminal 100 is held in the horizontal attitude by the user, the entire surface of the second touch screen 102 is set to be the effective region. When the user re-holds the portable terminal 100 in such a manner that the attitude of the portable terminal 100 changes from horizontal to vertical, the upper half of the second touch screen 102 is set to be the effective region and the lower half thereof is set to be the ineffective region.

At that time, the icon displayed on the screen of the liquid crystal display 106 changes from the icon 202 to the icon 201. However, since the icon is small in size, there is a fear that the user does not notice the change of the icon. To obviate this, in the present embodiment, a message indicating that the effective region of the second touch screen 102 has changed (a message “effective region of rear touch screen has changed” denoted by reference numeral 203 in the example of FIG. 7) is displayed for a predetermined period of time on the screen of the liquid crystal display 106. This enables the user to recognize that the effective region of the second touch screen 102 has changed. It should be noted that the user can be notified of the change by voice instead of being notified by the message.

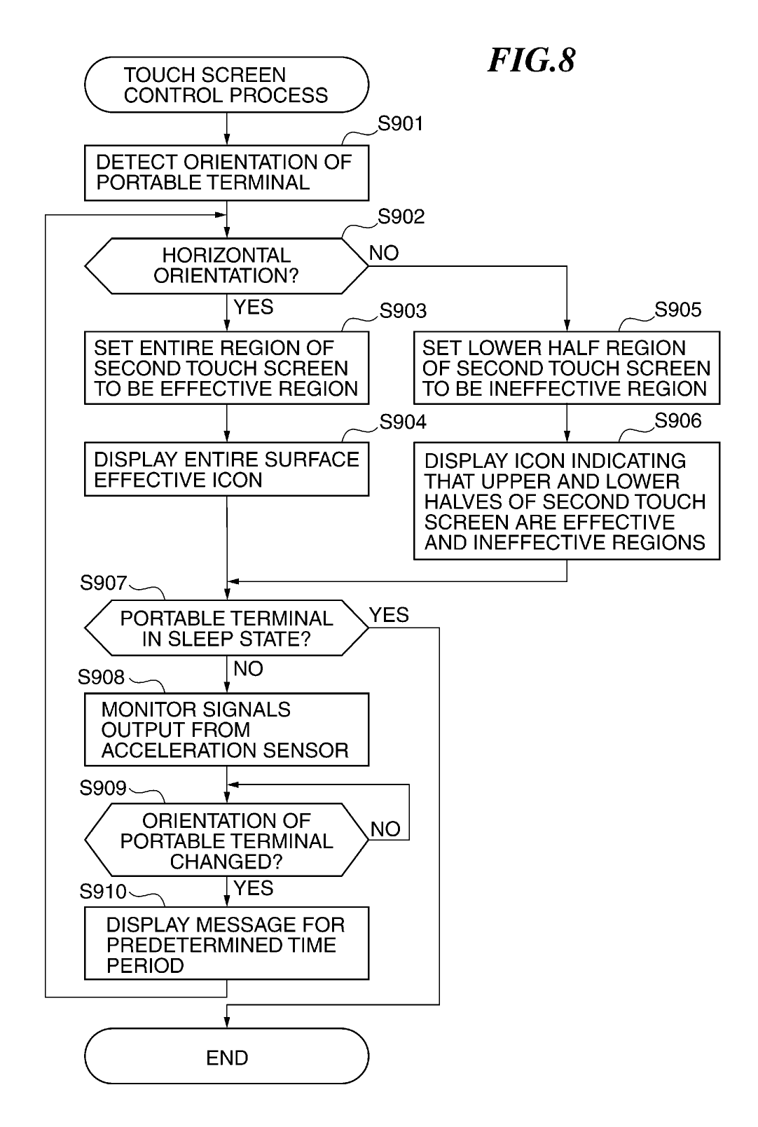

FIG. 8 shows in flowchart the procedures of a touch screen control process in which an icon indicating the ineffective and effective regions set on the second touch screen 102 is displayed on the screen of the liquid crystal display 106.

Referring to FIG. 8, the sensor controller 115 detects an orientation of the portable terminal 100 based on signals output from the acceleration sensor 114 (step S901), and determines whether the orientation of the portable terminal 100 is horizontal (step S902).

If the orientation of the portable terminal 100 is horizontal (YES to step S902), the operation controller 107 controls the second touch screen 102 in such a manner that the entire region of the second touch screen 102 is set to be the effective region (step S903), and causes the liquid crystal display 106 to display the entire surface effective icon (denoted by reference numeral 202 in FIGS. 6B and 7) on the screen (step S904).

On the other hand, if the orientation of the portable terminal 100 is not horizontal (NO to step S902), the operation controller 107 controls the second touch screen 102 in such a manner that the lower half region of the second touch screen 102 to which the palm of the holding hand may touch is set to be the ineffective region (step S905).

Next, in step S906, the operation controller 107 causes the liquid crystal display 106 to screen-display the icon (denoted by reference numeral 201 in FIGS. 6A and 7) indicating that upper and lower halves of the second touch screen 102 are the effective and ineffective regions, respectively.

In step S907, the CPU 108 determines whether the portable terminal 100 is in a sleep state. If the portable terminal 100 is in a sleep state (YES to step S907), the present process is completed.

On the other hand, if the portable terminal 100 is not in a sleep state (NO to step S907), the sensor controller 115 monitors the signals output from the acceleration sensor 114 (step S908), thereby continuing to detect the orientation of the portable terminal 100.

In step S909, the sensor controller 115 determines whether the orientation of the portable terminal 100 has changed. If the orientation of the portable terminal 100 has not changed (NO to step S909), the process returns to step S909. On the other hand, if the orientation of the portable terminal 100 has changed (YES to step S909), the operation controller 107 causes the liquid crystal display 106 to display the message (denoted by reference numeral 203 in FIG. 7), which indicates that the effective region or the ineffective region of the second touch screen 102 has changed, on the screen for a predetermined period of time (step S910). Then, the process returns to step S902.

According to the touch screen control process of FIG. 8, when the ineffective region or the effective region of the second touch screen 102 has changed, the user is enabled to easily recognize such a change.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment (s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2013-076197, filed Apr. 1, 2013, and No. 2014-051588, filed Mar. 14, 2014, which are hereby incorporated by reference herein in their entirety.

What is claimed is:

1. A portable terminal having a first touch screen combined with a display and having a second touch screen, comprising:
a detection unit configured to detect whether the portable terminal is held horizontally such that long sides of the portable terminal extend in a horizontal direction relative to a horizontal plane or held vertically such that the long sides of the portable terminal extend in a vertical direction relative to the horizontal plane; and
a control unit configured according to a result of detection by said detection unit to perform control to invalidate an operation to a partial region of the second touch screen and validate an operation to other regions.

2. The portable terminal according to claim 1, wherein in a case where said detection unit detects that the portable terminal is held vertically, said control unit performs control to invalidate an operation to a region of the second touch screen that may be touched by a user's hand.

3. The portable terminal according to claim 1, wherein in a case where said detection unit detects that the portable terminal is held horizontally, said control unit performs control to validate an operation to an entire region of the second touch screen.

4. The portable terminal according to claim 1, wherein at least one of an indication that indicates an ineffective region in which an operation of the second touch screen is invalidated and an indication that indicates an effective region in which an operation of the second touch screen is not invalidated is displayed on the display by using an icon.

5. The portable terminal according to claim 4, further including:
a notification unit configured, in a case where the ineffective region of the second touch screen has changed, to notify that the ineffective region has changed.

6. The portable terminal according to claim 2, wherein the region of the second touch screen that may be touched by the user's hand is a lower half region of the second touch screen.

7. The portable terminal according to claim 1, wherein in a case where an operation to the partial region of the second touch screen is invalidated, said control unit performs control to cut off power supply for operation detection to the partial region of the second touch screen.

8. The portable terminal according to claim 1, wherein in a case where an operation to the partial region of the second touch screen is invalidated, said control unit ignores a detection signal output from the second touch screen in response to the operation to the partial region of the second touch screen.

9. A control method for a portable terminal having a first touch screen combined with a display and having a second touch screen, comprising:
a detection step of detecting whether the portable terminal is held horizontally such that long sides of the portable terminal extend in a horizontal direction relative to a horizontal plane or held vertically such that the long sides of the portable terminal extend in a vertical direction relative to the horizontal plane; and
a control step of performing control to invalidate an operation to a partial region of the second touch screen and validate an operation to other regions according to a result of detection in said detection step.

10. A non-transitory computer-readable storage medium storing a program for causing a computer to execute a control method for a portable terminal having a first touch screen combined with a display and having a second touch screen, wherein:
the control method comprises a detection step of detecting whether the portable terminal is held horizontally such that long sides of the portable terminal extend in a horizontal direction relative to a horizontal plane or held vertically such that the long sides of the portable terminal extend in a vertical direction relative to the horizontal plane, and a control step of performing control to invalidate an operation to a partial region of the second touch screen and validate an operation to other regions according to a result of detection in the detection step.
